(19) United States
(12) Patent Application Publication
(10) Pub. No.: US 2021/0349884 A1
(43) Pub. Date: Nov. 11, 2021

(54) AUTOMATED DATASET DESCRIPTION AND UNDERSTANDING

(71) Applicant: AT&T Intellectual Property I, L.P., Atlanta, GA (US)

(72) Inventors: Jeffrey Aaron, Atlanta, GA (US); James Fan, San Ramon, CA (US)

(21) Appl. No.: 16/869,533

(22) Filed: May 7, 2020

(51) Int. Cl. G06F 16/23; G06F 40/40

(52) U.S. Cl. CPC G06F 16/2379; G06F 40/40

(57) ABSTRACT

A processing system may generate a first dataset according to a first policy set, record first metadata for the first dataset, generate a first enhanced dataset from the first dataset and a second dataset, according to a second policy set to associate the first and second datasets, and record second metadata including information regarding the second policy set that is applied to associate the first and second datasets, generate a second enhanced dataset derived from the first enhanced dataset and a third dataset according to a fifth policy set to associate the first enhanced dataset with at least the third dataset, the first and second datasets from a first domain and the third dataset from a second domain, record fifth metadata including information associated with the fifth policy set to associate the first enhanced dataset with the third dataset, and add the second enhanced dataset to a dataset catalog.

The present disclosure relates generally to telecommunication network database records management and utilization, and more particularly to methods, computer-readable media, and apparatuses for associating different datasets and enhancing datasets with metadata according to multiple sets of policies.

### BACKGROUND

Data scientists may spend time trying to familiarize themselves with data sources that are new to them. Many organizations are affected by this problem, especially large organizations with many different datasets and legacy systems. For example, data analysts, such as business intelligence personnel, data engineers, and other data scientists, may spend a substantial amount of time in meetings, sending e-mails, and making phone calls to colleagues trying to figure out what information the data sources contain, the limitations of the data sources, how to operate on the data sources, the schemas of the data sources, and so forth. In particular, data administrators may change over time, and the user bases of various data sources may also change as personnel retire or move on to different projects, different roles, or different organizations.

### SUMMARY

In one example, the present disclosure provides a method, computer-readable medium, and apparatus for associating different datasets and enhancing datasets with metadata according to multiple sets of policies. For example, a processing system including at least one processor may generate a first dataset according to a first set of policies, record first metadata for the first dataset, the first metadata including information associated with at least one policy of the first set of policies that is applied during the generating of the first dataset, generate a first enhanced dataset that is derived from at least a portion of the first dataset and at least a portion of a second dataset, according to a second set of policies, where each of the second set of policies comprises at least one second condition and at least one second action to associate the first dataset with at least the second dataset, and record second metadata for the first enhanced dataset, the second metadata including information associated with at least one policy of the second set of policies that is applied to associate the first dataset with the at least the second dataset. The processing system may further generate a second enhanced dataset that is derived from at least a portion of the first enhanced dataset and at least a portion of a third dataset according to a fifth set of policies, where each of the fifth set of policies comprises at least one fifth condition and at least one fifth action to associate the first enhanced dataset with at least the third dataset, where the first dataset and the at least the second dataset a from a first domain, and where the at least the third dataset is from at least a second domain that is different from the first domain. The processing system may then record fifth metadata for the second enhanced dataset, the fifth metadata including information associated with at least one policy of the fifth set of policies to associate the first enhanced dataset with at least the third dataset, and add the second enhanced dataset to a dataset catalog comprising a plurality of datasets.

### BRIEF DESCRIPTION OF THE DRAWINGS

The present disclosure can be readily understood by considering the following detailed description in conjunction with the accompanying drawings, in which:

FIG. 1 illustrates one example of a system including a telecommunication network, according to the present disclosure;

FIG. 2 illustrates an example architecture of a processing system according to the present disclosure, e.g., an automated data description and understanding unit for associating different datasets and enhancing datasets with metadata according to multiple sets of policies;

FIG. 3 illustrates a flowchart of at least a portion of an example method for associating different datasets and enhancing datasets with metadata according to multiple sets of policies, according to the present disclosure;

FIG. 4 illustrates an additional flowchart of at least a portion of an example method for associating different datasets and enhancing datasets with metadata according to multiple sets of policies, according to the present disclosure; and

FIG. 5 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for associating different datasets and enhancing datasets with metadata according to multiple sets of policies. For instance, users of datasets (including stored data and data streams) may have difficulty determining what each available dataset actually is, how it may be related to other datasets, and whether the dataset can be used for specific purposes. This will become increasingly important as use of machine learning becomes more widespread and datasets grow larger and more numerous. Examples of the present disclosure automatically generate metadata for datasets, providing users with thorough (and easy to understand) explanations of what information a dataset contains, how the data of the dataset was collected, processed, and/or transformed, and how each dataset may be similar or different from other datasets that are determined to be related or similar. The present disclosure extends beyond the typical approaches of labeling datasets with such things as titles and manually generated descriptions, which often (under anything except the simplest possible circumstances) may require costly and inefficient expert assistance in order to evaluate whether the dataset is suited for a particular use.

In one example, the present disclosure provides a multi-phase approach, where each phase involves automation and builds upon the previous phase(s). This spans the entire process from before data is collected to actually attempting to understand what the data includes, and thus to the actual use the data, e.g., by a human or automated system end-user. In one example, the present disclosure automatically establishes policies to add metadata regarding capabilities for collecting, generating, and/or processing data, adds descriptive metadata at the time of actual collection or processing of data for a dataset, and later analyzes resulting metadata across multiple datasets to add additional analysis metadata, such as information regarding similarities and/or contrasts/differences with metadata of other datasets. In one example, the present disclosure further provides analysis and interpretation of the total metadata pertinent to a dataset being considered for use by an end-user, while also generating further metadata regarding that consideration, and finally generates metadata regarding datasets, and data within datasets, that is/are selected for actual use. Various types of metadata are thus generated by processing system of the present disclosure in each of the phases of operation.

To illustrate, automatically generated metadata may include: how and when data is collected, identification of the system collecting the data, the characteristics of the system, the source(s) from which the data is collected, environmental factors when the data is collected, quality ratings of factors available, types of post-collection processing that are applied, which system performed the processing, when the processing was applied, a sequence of operations of the processing, identification of groups asserting ownership or other rights/limits, comparisons, contrasts, and/or differences with other similar data/datasets, “upstream” data and/or datasets that are included or used in the creation of a particular dataset, “downstream” data and/or datasets (created by inclusion or use of the particular dataset, users selecting the dataset, the purpose of use, feedback from users selecting and/or using the dataset, and so forth).

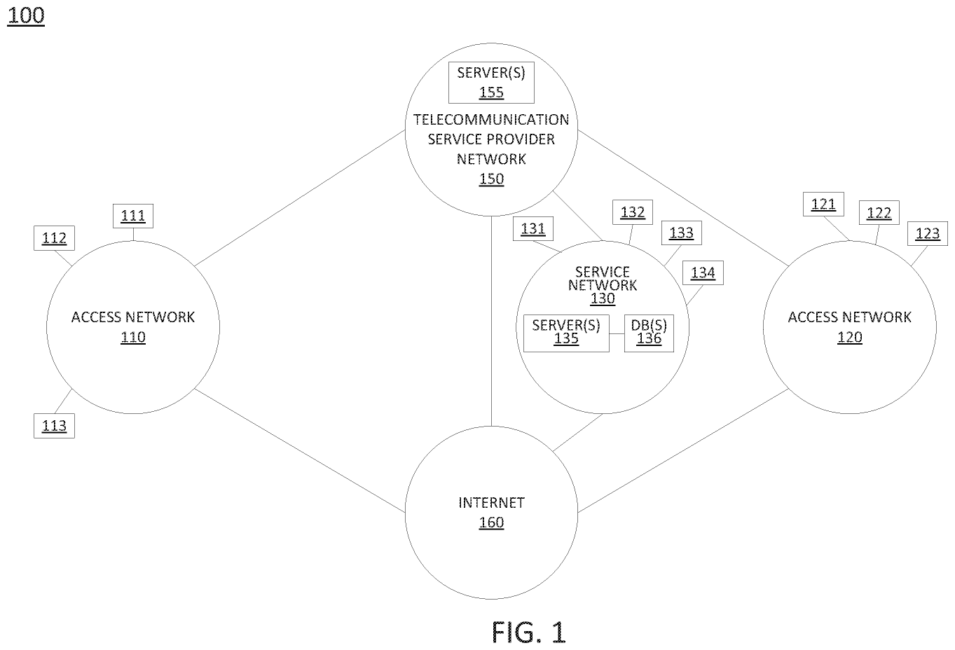

Examples of the present disclosure provide improved dataset (and underlying data) searching capabilities based on a much greater amount, and a more comprehensive variety of metadata. In addition, the amount of data available in the future, and the time to search may be exponentially greater than today. Notably, finding the right data for a particular task may be increasingly difficult without proportional improvements in search capabilities. The automated dataset metadata generation of the present disclosure may reduce or eliminate the need for data experts to manually document what each dataset contains, the history related to each dataset, and so forth. The automatically generated metadata also enables more advance searching capabilities on metadata of all datasets, and enables fast comparing and contrasting of similar datasets that may satisfy a data request. This is in contrast to a traditional search, which may return all possible results for a search, and which may rely on the end-user to parse and figure out the best result(s). For instance, such a search may easily provide too many results, possibly requiring substantial manual effort to evaluate candidate datasets. The present disclosure provides a response with the best matching datasets with detailed explanations based upon the automatically generated metadata, e.g., what each dataset includes, the history of the dataset, any related datasets, how the dataset may have been collected, aggregated, enhanced, joined, and/or merged with other datasets, which end-users have previously queried and/or used the dataset, the popularity of the dataset in general and/or among specific types of end-users, and so forth. These and other aspects of the present disclosure are discussed in greater detail below in connection with the examples of FIGS. 1-5.

To aid in understanding the present disclosure, FIG. 1 illustrates an example system 100 comprising a plurality of different networks in which examples of the present disclosure may operate. Telecommunication service provider network 150 may comprise a core network with components for telephone services, Internet services, and/or television services (e.g., triple-play services, etc.) that are provided to customers (broadly “subscribers”), and to peer networks. In one example, telecommunication service provider network 150 may combine core network components of a cellular network with components of a triple-play service network. For example, telecommunication service provider network 150 may functionally comprise a fixed-mobile convergence (FMC) network, e.g., an IP Multimedia Subsystem (IMS) network. In addition, telecommunication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication service provider network 150 may also further comprise a broadcast television network, e.g., a traditional cable provider network or an Internet Protocol Television (IPTV) network, as well as an Internet Service Provider (ISP) network. With respect to television service provider functions, telecommunication service provider network 150 may include one or more television servers for the delivery of television content, e.g., a broadcast server, a cable head-end, a video-on-demand (VoD) server, and so forth. For example, telecommunication service provider network 150 may comprise a video super hub office, a video hub office and/or a service office/central office.

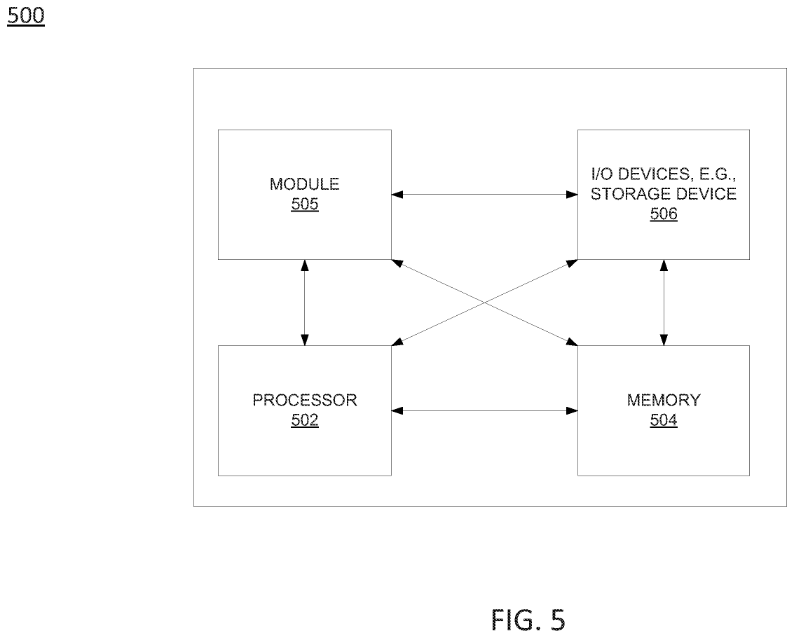

In one example, telecommunication service provider network 150 may also include one or more servers 155. In one example, the servers 155 may each comprise a computing device or processing system, such as computing system 500 depicted in FIG. 5, and may be configured to host one or more centralized and/or distributed system components. For example, a first system component may comprise a database of assigned telephone numbers, a second system component may comprise a database of basic customer account information for all or a portion of the customers/subscribers of the telecommunication service provider network 150, a third system component may comprise a cellular network service home location register (HLR), e.g., with current serving base station information of various subscribers, and so forth. Other system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other system components may include, for example, a layer 3 router, a short message service (SMS) server, a voicemail server, a video-on-demand server, a server for network traffic analysis, and so forth. It should be noted that in one example, a system component may be hosted on a single server, while in another example, a system component may be hosted on multiple servers in a same or in different data centers or the like, e.g., in a distributed manner. For ease of illustration, various components of telecommunication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, endpoint devices 121-123, and service network 130, and between telecommunication service provider network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. For example, one or both of the access networks 110 and 120 may comprise an ISP network, such that endpoint devices 111-113 and/or 121-123 may communicate over the Internet 160, without involvement of the telecommunication service provider network 150. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of endpoint devices 111-113 and 121-123 may represent one or more user/subscriber devices. In addition, in one example, any of endpoint devices 111-113 and 121-123 may comprise a device of an end-user (e.g., of an automated data description and understanding unit or processing system, as referred to herein).

In one example, the access networks 110 and 120 may be different types of access networks. In another example, the access networks 110 and 120 may be the same type of access network. In one example, one or more of the access networks 110 and 120 may be operated by the same or a different service provider from a service provider operating the telecommunication service provider network 150. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where telecommunication service provider network 150 may comprise a public land mobile network (PLMN)-universal mobile telecommunications system (UMTS)/General Packet Radio Service (GPRS) core network, or the like. In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, an Internet Protocol private branch exchange (IPPBX), and so forth, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the telecommunication service provider network 150. For example, the service network 130 may comprise one or more devices for providing services to subscribers, customers, and/or users. For example, telecommunication service provider network 150 may provide a cloud storage service, web server hosting, and other services. As such, service network 130 may represent aspects of telecommunication service provider network 150 where infrastructure for supporting such services may be deployed.

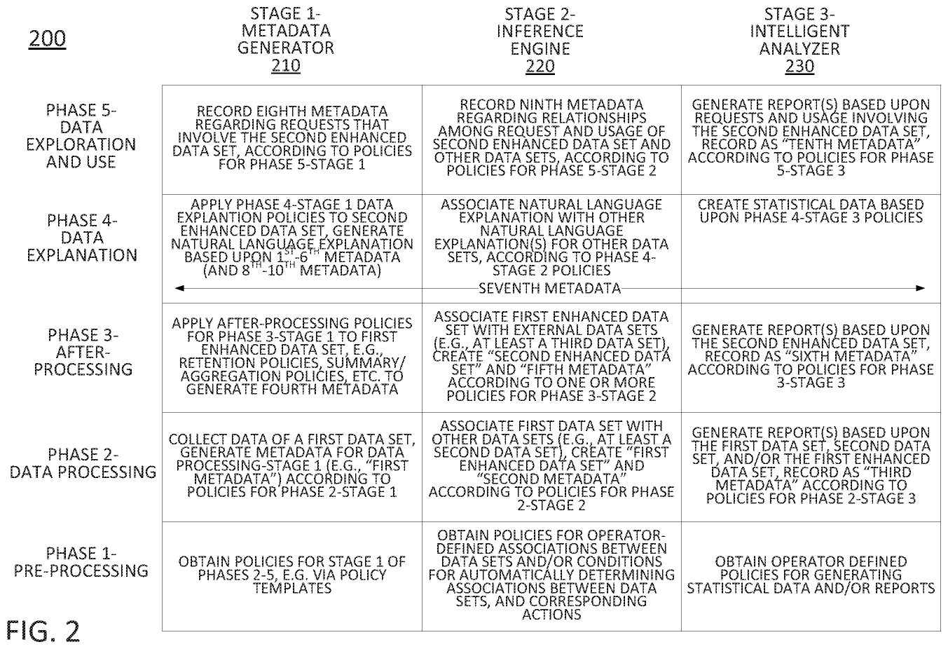

In one example, the service network 130 links one or more devices 131-134 with each other and with Internet 160, telecommunication service provider network 150, devices accessible via such other networks, such as endpoint devices 111-113 and 121-123, and so forth. In one example, devices 131-134 may each comprise a telephone for analog or digital telephony, a mobile device, a cellular smart phone, a laptop, a tablet computer, a desktop computer, a bank or cluster of such devices, and the like. In an example where the service network 130 is associated with the telecommunication service provider network 150, devices 131-134 of the service network 130 may comprise devices of network personnel, such as customer service agents, sales agents, marketing personnel, or other employees or representatives who are tasked with addressing customer-facing issues and/or personnel for network maintenance, network repair, construction planning, and so forth. Similarly, devices 131-134 of the service network 130 may comprise devices of network personnel responsible for operating and/or maintaining an automated data description and understanding unit or processing system, such as illustrated in FIG. 2 and described in greater detail below.

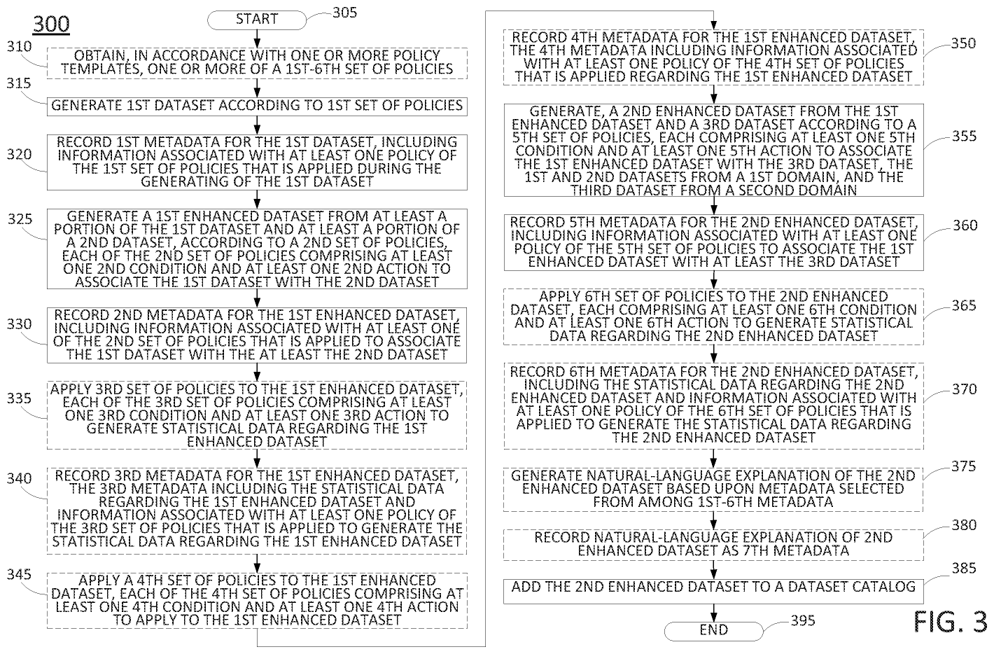

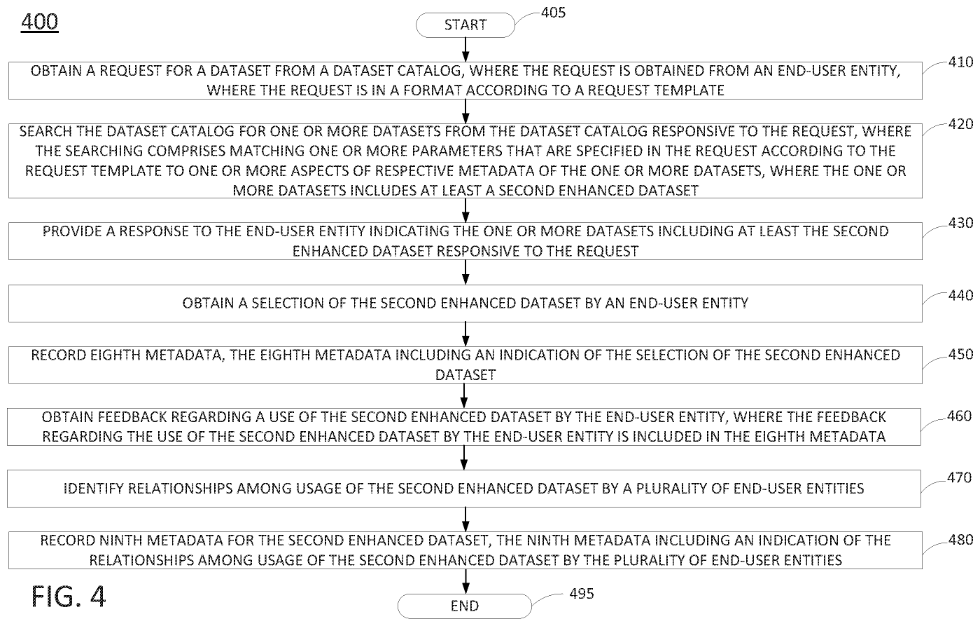

In the example of FIG. 1, service network 130 may include one or more servers 135 which may each comprise all or a portion of a computing device or processing system, such as computing system 500, and/or a hardware processor element 502 as described in connection with FIG. 5 below, specifically configured to perform various steps, functions, and/or operations for associating different datasets and enhancing datasets with metadata according to multiple sets of policies, as described herein. For example, one of the server(s) 135, or a plurality of servers 135 collectively, may perform operations in connection with the example method 300 of FIG. 3 and/or the example method 400 of FIG. 4, or as otherwise described herein. Similarly, one or more of the server(s) 135 may represent an automated data description and understanding unit or processing system, such as illustrated in FIG. 2 and described in greater detail below.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 5 and discussed below) or multiple computing devices collectively configured to perform various steps, functions, and/or operations in accordance with the present disclosure.

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in support of examples of the present disclosure for associating different datasets and enhancing datasets with metadata according to multiple sets of policies. As just one example, DB(s) 136 may be configured to receive and store network operational data collected from the telecommunication service provider network 150, such as call logs, mobile device location data, control plane signaling and/or session management messages, data traffic volume records, call detail records (CDRs), error reports, network impairment records, performance logs, alarm data, television usage information, such as live television viewing, on-demand viewing, etc., and other information and statistics, which may then be compiled and processed, e.g., normalized, transformed, tagged, etc., and forwarded to DB(s) 136, such as via one or more of the servers 155. In one example, such network operational data may further include data and/or records collected from access networks 110 and 120 (e.g., where access networks 110 and 120 are a part of and/or controlled by telecommunication service provider network 150).

In one example, DB(s) 136 may be configured to receive and store records from customer, user, and/or subscriber interactions, e.g., with customer facing automated systems and/or personnel of a telecommunication network service provider or other entities associated with the service network 130. For instance, DB(s) 136 may maintain call logs and information relating to customer communications which may be handled by customer agents via one or more of the devices 131-134. For instance, the communications may comprise voice calls, online chats, etc., and may be received by customer agents at devices 131-134 from one or more of devices 111-113, 121-123, etc. The records may include the times of such communications, the start and end times and/or durations of such communications, the touchpoints traversed in a customer service flow, results of customer surveys following such communications, any items or services purchased, the number of communications from each user, the type(s) of device(s) from which such communications are initiated, the phone number(s), IP address(es), etc. associated with the customer communications, the issue or issues for which each communication was made, etc.

Alternatively, or in addition, any one or more of devices 131-134 may comprise an interactive voice response system (IVR) system, a web server providing automated customer service functions to subscribers, etc. In such case, DB(s) 136 may similarly maintain records of customer, user, and/or subscriber interactions with such automated systems. The records may be of the same or a similar nature as any records that may be stored regarding communications that are handled by a live agent. Similarly, any one or more of the devices 131-134 may comprise a device deployed at a retail location that may service live/in-person customers. In such case, the one or more of devices 131-134 may generate records that may be forwarded and stored by DB(s) 136. The records may comprise purchase data, information entered by employees regarding inventory, customer interactions, surveys responses, the nature of customer visits, etc., coupons, promotions, or discounts utilized, and so forth. In still another example, any one or more of the devices 111-113 or 121-123 may comprise a device deployed at a retail location that may service live/in-person customers and that may generate and forward customer interaction records to DB(s) 136.

The various data and/or records collected from various components of telecommunication service provider network 150 (e.g., server(s) 155), access networks 110 and 120, and/or service network 130 may be organized into and referred to as “datasets.” This includes both “streaming” and “batch” data, or both “data at rest” and “data in motion.”

In one example, DB(s) 136 may alternatively or additionally receive and/or store data from one or more external entities. For instance, DB(s) 136 may receive and store weather data from a device of a third-party, e.g., a weather service, a traffic management service, etc. via one of access networks 110 or 120. To illustrate, one of endpoint devices 111-113 or 121-123 may represent a weather data server (WDS). In one example, the weather data may be received via a weather service data feed, e.g., an NWS extensible markup language (XML) data feed, or the like. In another example, the weather data may be obtained by retrieving the weather data from the WDS. In one example, DB(s) 136 may receive and store weather data from multiple third-parties. In still another example, one of endpoint devices 111-113 or 121-123 may represent a server of a traffic management service and may forward various traffic related data to DB(s) 136, such as toll payment data, records of traffic volume estimates, traffic signal timing information, and so forth. Similarly, one of endpoint devices 111-113 or 121-123 may represent a server of a consumer credit entity (e.g., a credit bureau, a credit card company, etc.), a merchant, or the like. In such an example, DB(s) 136 may obtain one or more datasets/data feeds comprising information such as: consumer credit scores, credit reports, purchasing information and/or credit card payment information, credit card usage location information, and so forth. In one example, one of endpoint devices 111-113 or 121-123 may represent a server of an online social network, an online gaming community, an online news service, a streaming media service, or the like. In such an example, DB(s) 136 may obtain one or more datasets/data feeds comprising information such as: connections among users, specific media or types of media accessed, the access times, the durations of media consumption, games played, durations of game play, and so forth.

It should be noted that for all of the above examples, the data, records, or other information collected from external entities may also be organized into and referred to as “datasets.” In accordance with the present disclosure, DB(s) 136 may further store metadata associated with various datasets, e.g., as described in greater detail in connection with the examples of FIGS. 2-4, as well as “enhanced data” sets, which may comprise combinations of datasets via operations such as “join,” “union,” “intersect,” etc. In one example, DB(s) 136 may also store policies and/or rules associated with the processing of datasets as described herein, such as data collection policies, data retention policies, policies for associating and combining datasets, policies for generating reporting data regarding various datasets, policies for associating dataset queries, dataset utilizations, and so forth. In addition, DB(s) 136 may also store data schema(s), e.g., for data formatting, data naming, data size, etc. with respect to various datasets (both individually and collectively), and with respect to datasets as a whole, as well as the component records and fields thereof.

In addition, with respect to all of the above examples, it should be noted that the datasets may be accessed by server(s) 135 and/or DB(s) 136 via application programming interfaces (API) or other access mechanisms between computing systems, and may include data that is specifically formatted and/or processed so as to maintain user privacy and/or anonymity, and/or such that the data that is accessed is in accordance with user-granted permissions, preferences, or the like, as well as any applicable contractual, legal, and/or regulatory obligations of either the provider(s) of such data, and/or the operator of server(s) 135 and/or DB(s) 136, as an accessor of the data.

In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. As noted above, in one example, one or more of servers 135 may comprise a processing system that is configured to perform operations for associating different datasets and enhancing datasets with metadata according to multiple sets of policies, as described herein. For instance, flowcharts of example methods 300 and 400 including aspects of associating different datasets and enhancing datasets with metadata according to multiple sets of policies are illustrated in FIGS. 3 and 4 and described in greater detail below.

Additional operations of server(s) 135 for associating different datasets and enhancing datasets with metadata according to multiple sets of policies, and/or server(s) 135 in conjunction with one or more other devices or systems (such as DB(s) 136) are further described below in connection with the example of FIG. 2. In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 110 and 120, in another service network connected to Internet 160 (e.g., a cloud computing provider), in telecommunication service provider network 150, and so forth. Thus, these and other modifications are all contemplated within the scope of the present disclosure.

FIG. 2 illustrates an example conceptual architecture of a processing system 200 for associating different datasets and enhancing datasets with metadata according to multiple sets of policies, in accordance with the present disclosure. The processing system 200 integrates various metadata automatically generated at each phase of a multi-phase process for data collection, data enhancement, and data selection and use (e.g., phases 1-5). By intelligently creating proper metadata at each point, continually analyzing and cross-analyzing the metadata, and intelligently adding/incorporating additional metadata, the processing system 200 may provide and track information that is pertinent to understanding each particular dataset (and the data therein), such that selection and use of such those datasets is enhanced. As illustrated in FIG. 2, the processing system 200 includes three modules, a metadata generator (MG) 210, an inference engine (IE) 220, and an intelligent analyzer (IA) 230, which operate in three stages (stages 1-3), across five phases (phases 1-5). In the present example, the five phases include: phase 1—pre-processing phase (PPP), phase 2—data processing phase (DPP), phase 3—after-processing phase (APP), phase 4—data explanation phase (DEP), and phase 5—data selection/use phase (DSUP). Each phase uses the same creation modules (metadata generator 210, inference engine 220, and intelligent analyzer 230) to generate corresponding metadata. In one example, the processing system 200 and each of the modules 210, 220, 230, and so forth, may comprise all or a portion of a computing device or processing system, such as computing system 500, and/or a hardware processor element 502 as described in connection with FIG. 5 below, specifically configured to perform various steps, functions, and/or operations for associating different datasets and enhancing datasets with metadata according to multiple sets of policies, as described herein.

In one example, the pre-processing phase (phase 1) includes the establishment and creation of rules/policies for data processing and metadata generation at subsequent phases (phases 2-4). In one example, in stage 1, the metadata generator 210 examines the raw data in preparation for data collection in phase 2 (e.g., in examples where the data is already collected and stored in some form in a data storage system). In one example, the metadata generator 210 provides for the establishment of schemas for a dataset (e.g., a “first dataset”), for enhanced datasets to be created therefrom, and the underlying data records thereof. For instance, the schema(s) may include naming rules, data/field formatting, records formatting, a structure, such as a table structure, a graph structure, or the like, and so forth. The policies, or rules, that are established via the metadata generator 210 at phase 1 may include one or more data collection policies, such as: the times for collecting data of the first dataset, a frequency for collecting the data of the first dataset, one or more sources for collecting the data of the first dataset, a geographic region or a network zone for collecting the data of the first dataset, and/or at least one type of data to collect for the data of the first dataset, the retention period for the dataset and/or portions thereof, and so forth. In one example, the metadata generator 210 at phase 1 may also establish data processing policies/rules for processing the first dataset. For instance, each policy may include at least one condition, and at least one action, such as: merging, aggregating, joining, filtering, truncating, cleansing, etc. In one example, at phase 1, the metadata generator 210 may also establish policies/rules regarding who or which system(s) is/are authorized to collect the data, the retention period for the data, and so forth.

It should be noted that in each case, the policies may be provided by operations staff/personnel. In one example, the metadata generator 210 provides policy/rule templates from which operators staff may fill-in and/or adjust parameters, definitions, names, etc. such that deployable policies/rules may be formed from such templates. Examples of policies established via the metadata generator 210 at phase 1 may include: File Name Policy—“CollectorMachineName+NetworkZone+Timestamp;” Frequency Policy—“Hours 0-8: 30 mins, Hours 8-18: 15 mins, Hours 18-24: 60 mins;” File Classification Policy—“FileName xxx—yyy: type 1, aaa-ccc: type 2;” Retention Policy—“type 1: 3 months, type 2: 6 months;” Other Relationships Policy—“Region N→Region M, Region P→Region Q.”

At phase 1-stage 2, the inference engine 220 retrieves or provides for the creation of polices/rules specified by operations staff to define relationships/associations of the first dataset to other datasets (which may be referred to herein as “manually defined hooks”). The policies may further define data processing operations for generating an “enhanced dataset” comprising a combination of the first dataset (or at least a portion thereof) and at least a second dataset (or at least a portion, or portions thereof). These policies may also be established via policy templates that may be provided by the inference engine 220 for operations staff to fill-in and/or adjust parameters, definitions, names, etc. Examples of such policies may include: Correlation Policy—“Merge N and M, Merge P and Q;” Retention Policy—“Merged set: 6 months;” Summation Policy—“tally min data to hourly data;” Cleansing Policy—“project networknode id, hourly_total, timestamp_for_the_record, region_indicator.” These policies enable creation of new data views, and provide an enhanced dataset (e.g., a “first enhanced dataset”) that is ready for further processing by the intelligent analyzer 230.

At phase 1-stage 3, the intelligent analyzer 230 retrieves or provides for the creation of polices/rules specified by operations staff to derive insights and provide reports regarding the first enhanced dataset. These policies may also be established via policy templates that may be provided by the intelligent analyzer 230 for operations staff to fill-in and/or adjust parameters, definitions, names, etc. Examples of such policies may include: Trending Policy: “Generate trending reports for region M and N individually, compare the daily trend and weekly trend →output to trending comparison metafile.” It should again be noted that at the pre-processing phase (phase 1), the modules only look at the way to generate the first dataset, the first enhanced dataset, and the insights/reports and other metadata. In one example, policies that are generated at phase 1 may be organized into sets of policies (e.g., each set comprising one or more policies) that are designated for respective phases and stages of the multi-phase process illustrated in the architecture of processing system 200 of FIG. 2.

Next, in the data processing phase (phase 2), the first dataset is generated at stage 1 via the metadata generator 210. For instance, at phase 2-stage 1, the metadata generator 210 may apply a first set of policies, which may include one or more data collection policies, such as: a time for collecting data of the first dataset, a frequency for collecting the data of the first dataset, one or more sources for collecting the data of the first dataset, at least one type of data to collect for the data of the first dataset and so forth. In one example, the metadata generator 210 may therefore collect the specified data according to the one or more data collection policies. In addition, the metadata generator 210 may format or process the data in accordance with one or more data schema, which may define data formatting requirements, naming requirements, and so forth, for data fields, records, and/or the structure of the first dataset overall (e.g., a table format, a graph format, etc.).

In addition, the first set of policies applied by the metadata generator 210 may further include one or more data processing policies. For instance, each policy or “rule” may include at least one “condition,” and at least one “action.” With respect to the data processing policies that may be applied at phase 2-stage 1, a condition may comprise “time is >=0800 and <1400,” “number of calls is >10,” “region=7 or 12,” “account_active=true, size is >500 MB,” “temperature is >15 and <33,” “dataset 1 column 3 is_equal_to dataset X column 6,” and so forth. The at least one action may comprise a combining of data via operators such as “join,” “union,” “intersect,” “merge,” “append,” etc., aggregating, such as calculating averages, moving averages, or the like, sampling (e.g., selecting a high, median, and/or low value, selecting a 75^{th} percentile value, a 25^{th} percentile value, and so forth), enhancing (e.g., including cleansing, filtering, truncating, anonymizing, randomizing, hashing, etc.), or other operations with respect to the first dataset (which may include applying combinations or sequences of such actions), and so forth. In addition to performing operations for data collection and data processing according to policies applicable to stage 2-phase 1, the metadata generator 210 may also create “first metadata” which may record which policies were used, e.g., which policies' conditions were satisfied, and the action(s) performed in response to detecting the respective condition(s), the times of applying such policies, and so forth.

At phase 2-stage 2, the inference engine 220 may apply a second set of policies to associate the first dataset with at least a second dataset. For instance, the second set of policies may have previously been established via the inference engine 220 at phase 1. Each of the second set of policies may include at least one condition (e.g., to identify at least one relationship) and at least one action to be implemented responsive to the identification of the relationship according to the at least one condition. For instance, the at least one condition may be: “region is 12 or 15,” “time is >=0800 and <1400,” etc. In one example, the conditions may be based upon matching of metadata, such as “device_type is equal” (e.g., both the first dataset and the at least the second dataset are for device_type “eNodeB” and include this same parameter in a metadata field for device_type. For example, the first metadata generated at phase 2-stage 1 by the metadata generator 210 may include “eNodeB” in a “device_type” metadata field. The at least the second dataset may similarly have associated metadata with this same value in the same field. For instance, the second dataset may be collected and enhanced in a similar manner as discussed herein via the processing system 200. However, for ease of illustration, a detailed discussion of this similar process is omitted from the present disclosure. In one example, a condition of at least one policy of the second set of policies may include a distance metric for identifying at least one relationship between the first dataset and at least the second dataset. For instance, the distance metric may be associated with a geographic distance, a network topology-based distance, or a similarity distance among one or more metadata features of the first dataset and at least the second dataset.

In any case, upon detection of the one or more conditions of one or more policies of the second set of policies being satisfied, the inference engine 220 may perform one or more corresponding actions to produce a resulting “first enhanced dataset” that is based upon/derived from at least a portion of the first dataset and at least a portion of at least the second dataset. For instance, according to the one or more policies of the second set of policies, the inference engine may combine at least a portion of the first dataset with at least a portion of the second dataset (e.g., via an operator such as “join,” “union,” “intersect,” “merge,” “append,” etc.). In one example, the inference engine 220 may alternatively or additionally aggregate at least one of: at least a portion of the first dataset, at least a portion of the second dataset, or at least a portion of the first enhanced dataset (e.g., averaging, sampling, etc.). In one example, the inference engine 220 may alternatively or additionally enhance at least a portion of the first enhanced dataset (which may include cleansing, filtering, truncating, anonymizing, randomizing, hashing, etc.). In addition to performing operations for associating/combining datasets according to policies applicable to stage 2-phase 2, the inference engine 220 may also create “second metadata” which may record which policies of the second set of policies were used, e.g., which policies' conditions were satisfied, and the action(s) performed in response to detecting the respective condition(s), the times of applying such policies, and so forth.

At phase 2-stage 3, the intelligent analyzer 230 may apply a third set of policies to the first enhanced dataset. For instance, each of the third set of policies may comprise at least one condition and at least one action to generate statistical data regarding the first enhanced dataset. The policies may be set by operator personnel in phase 1, as discussed above. The conditions may be similar to the above-described conditions for the first set of policies and/or the second set of policies, and may be evaluated against the first metadata and/or the second metadata that may be generated at stages 1 and 2 of phase 2. For instance, the statistical data may comprise analysis of metadata (e.g., comparisons, contrasts, and/or differences between metadata), a trending report of data of various tables, rows, columns, clusters, etc., a report of high, low, and median values for various fields of data in the first enhanced dataset, and so forth. Accordingly, in one example, the intelligent analyzer 230 may look to the underlying data of the first enhanced dataset to generate the statistical data, e.g., as an alternative or in addition to evaluating the first metadata and/or second metadata. In addition, at phase 2-stage 3, intelligent analyzer 230 may also create and/record “third metadata,” which may include the statistical data regarding the first enhanced dataset, as well as information associated with at least one policy of the third set of policies that is applied to generate the statistical data regarding the first enhanced dataset.

As illustrated in FIG. 2, the processing system 200 further implements an after-processing phase (phase 3). At phase 3-stage 1, the metadata generator 210 may apply a fourth set of policies which may include one or more additional data processing policies to be applied to the first enhanced dataset. For instance, the conditions of the polices of the fourth set of policies may be of the same or a similar nature as the various example conditions discussed above with respect to the first, second, and third sets of policies. Similarly, the corresponding actions may include combining operations, aggregating operations, and/or enhancing operations with respect to the data of the first enhanced dataset (it should be noted that the “combining” may be for different columns, rows, tables, fields, partitions, graphs, etc. within the first enhanced dataset itself, and does not involve any other datasets). It should also be noted that the policies of the fourth set of policies may be of a type that could alternatively be implemented at part of the second set of policies utilized at phase 2-stage 2. However, in one example, the policies applied at phase 3 (including all of stages 1-3) may be defined by operator personnel of a different category from operator personnel who may define the policies that are for application at phase 2. For instance, policies for application at phase 3 may be defined by supervisory personnel, may be defined by subject matter experts, and so forth. Thus, for example, a shorter data retention policy of the fourth set of policies may supersede or override a data retention policy that may be applied from the second set of policies. In addition, at phase 3-stage 1, the metadata generator 210 may also record fourth metadata for the first enhanced dataset, the fourth metadata including information associated with at least one policy of the fourth set of policies that is/are applied with respect to the first enhanced dataset.

At phase 3-stage 2, the inference engine 220 may apply a fifth set of policies, where each of the fifth set of policies comprises at least one condition and at least one action to associate the first enhanced dataset with at least a third dataset, where the first dataset and the at least the second dataset are from a first domain, and where the at least the third dataset is from a different domain (or domains). For instance, the first dataset and the at least the second dataset (and hence the first enhanced dataset) may be from a first domain, and a third dataset may be from a second domain that is different from the first domain. To illustrate, the first dataset may be associated with access network 110 of FIG. 1 and the second dataset may be associated with access network 120 of FIG. 1. In other words, the first domain may be “telecommunication network data.” In various examples, the second domain may comprise: 3^{rd} party streaming media service data (e.g., from an over-the-top (OTT) streaming service), social network data, weather data, credit card records data, aggregate airline travel information, and so forth.

In this regard, it should again be noted that in one example, the policies applied at phase 3 (including those of the fifth set of policies to be applied by the inference engine 220 at phase 3-stage 2) may be designated by supervisory personnel, subject-matter experts, etc. For instance, those personnel who may establish policies to be applied at phase 2 may be unaware of other data sources that may be available from other domains. However, supervisory personnel may have insight into arrangements to access and/or exchange data across domains, and may therefore establish policies that may specify how and whether to associate data from the telecommunication network domain with other domains, such as social network utilization data, OTT streaming services data, and so forth.

The policies of the fifth set of policies may be similar to those of the second set of policies applied at phase 2-stage 2, but may comprise conditions to identify at least one relationship between metadata of the third dataset and at least one of the first metadata, the second metadata, the third metadata, or the fourth metadata generated in the previous stages and phases. Upon detection of the one or more conditions of one or more policies of the fifth set of policies being satisfied, the inference engine 220 may perform one or more corresponding actions to produce a resulting “second enhanced dataset” that is based upon/derived from at least a portion of the first enhanced dataset and at least a portion of at least the third dataset. For instance, the inference engine 220 may perform combining operations. In one example, the inference engine 220 may alternatively or additionally aggregate at least one of: at least the portion of the first enhanced dataset, at least the portion of the third dataset, or the second enhanced dataset. In one example, the inference engine 220 may alternatively or additionally apply enhancing operations to at least one of: at least the portion of the first enhanced dataset, at least the portion of the third dataset, or the second enhanced dataset. In one example, at least one of the conditions of at least one policy of the fifth set of policies may comprise an inter-domain “distance metric,” similar to the second set of policies for intra-domain data associations. In addition to performing operations for associating/combining datasets according to policies applicable to stage 3-phase 2, the inference engine 220 may also create “fifth metadata,” which may record which policies of the fifth set of policies were used, e.g., which policies' conditions were satisfied, and the action(s) performed in response to detecting the respective condition(s), the times of applying such policies, and so forth.

At phase 3-stage 3, the intelligent analyzer may apply a sixth set of policies to the second enhanced dataset. For instance, each of the sixth set of policies may comprise at least one condition and at least one action to generate statistical data regarding the second enhanced dataset. The conditions may be similar to the above-described conditions for the third set of policies applied at phase 2-stage 3, however with respect to the second enhanced dataset, and may be evaluated against the 1^{st}-5^{th} metadata that may be generated at prior stages of phases 2 and 3. For instance, the statistical data may comprise analysis of metadata (e.g., comparisons, contrasts, and/or differences between metadata), a trending report of data of various tables, rows, columns, clusters, etc., a report of high, low, and median values for various fields of data in the first enhanced dataset, and so forth. Accordingly, in one example, the intelligent analyzer 230 may look to the underlying data of the second enhanced dataset to generate the statistical data, e.g., as an alternative or in addition to analyzing the 1^{st}-5^{th} metadata. In addition, at phase 3-stage 3, intelligent analyzer 230 may also create and/record “sixth metadata,” which may include the statistical data regarding the second enhanced dataset, as well as information associated with at least one policy of the sixth set of policies that is applied to generate the statistical data regarding the second enhanced dataset.

Phase 4, the data explanation phase, starts with the metadata generator 210 at stage 1, and further includes the inference engine 220 and the intelligent analyzer 230 at stages 2 and 3, respectively. Collectively, phase 4 may include generating a natural-language explanation of the second enhanced dataset based upon at least a portion of metadata selected from among the 1^{st}-6^{th} metadata, and recording the natural-language explanation of the second enhanced dataset as seventh metadata. The metadata generator 210 may apply phase 4-stage 1 data explanation policies, which may define which aspects from the 1^{st}-6^{th} metadata is relevant to be included in the natural-language explanation, e.g., the “condition(s).” The “action(s)” may include applying a natural-language generating algorithm to create the natural-language explanation from the relevant metadata.

In one example, the inference engine 220 may associate the natural language explanation with other natural language explanations for other datasets, e.g., according to one or more natural-language explanation association policies. For instance, a policy may indicate to associate natural-language explanations when there is a threshold overlap in a number of words, when a certain relevant keyword utilization exceeds a threshold, and so forth. In one example, the associations that may be identified may be recorded in the seventh metadata. In addition, intelligent analyzer 230 may create statistical data based upon one or more predefined phase 4-stage 3 policies. In one example, the metadata generator 210, the inference engine 220, and the intelligent analyzer 230 may also process metadata from phase 5 as described in greater detail below.

Phase 5 comprises a “data selection and use phase” (DSUP). At phase 5-stage 1, metadata generator 210 may obtain queries and selections of the second enhanced dataset, and may record eighth metadata for the second enhanced dataset, the eighth metadata including an indication of the selection (and/or the querying) of the second enhanced dataset, e.g., a timestamp of the selection, the end-user or system selecting the second enhanced dataset, the type of end-user or group (e.g., marketing, operations, customer care, etc.), and so forth. In one example, the types of information retained as eighth metadata regarding the usage of the second enhanced dataset may be specified in pre-defined policies for phase 5-stage 1.

In one example, querying of the second enhanced dataset may involve queries that specify the second enhanced dataset, or queries that are not specific, but which may be matched to the second enhanced dataset via one or more search parameters. For instance, the first dataset may comprise viewing records relating to a first zone or region of a telecommunication network, the second dataset may comprise viewing records relating to a second zone/region of the telecommunication network, the third dataset may relate to viewing records from an OTT streaming service, and the second enhanced dataset may therefore collectively relate to cross-domain/multi-domain viewing records. Continuing with the present example, a search/or query may relate to movie viewership and may specify the first zone of the telecommunication network. However, the submitter of the request/query may be unaware of the availability of possibly related data from the second zone of the telecommunication network, as well as the possibly related data from the external domain (e.g., the OTT streaming service). Nevertheless, the second enhanced dataset may be returned as a possible result that is responsive to the request/query, due to the data associations captured in the various metadata that is generated as described above. In any case, the queries or requests that may involve the second enhanced dataset may be recorded in the eighth metadata. In one example, the metadata generator 210 may also obtain feedback regarding a use of the second enhanced dataset by the end-user entity, which may further be included in the eighth metadata.

At phase 5-stage 2, the inference engine 220 may apply a set of policies to identify relationships among usage of the second enhanced dataset by a plurality of end-user entities. It should be noted that as referred to herein, an end-user entity may include a human user, or an automated device or system. In various examples, the second enhanced dataset (and other datasets that may be queried, requested, and/or utilized) may be used for a variety of machine learning ML) tasks, such as training machine learning models, testing machine learning models, retraining machine learning models, and so forth. Alternatively, or in addition, the second enhanced dataset (and other datasets) may be obtained for stream processing by various ML models that may be deployed in a production environment for various useful tasks, such as firewall operations, filtering operations, object detection and recognition operations, content recommendation operations, network event prediction operations, and so forth.

The inference engine 220 may, for example, relate the requests for the second enhanced dataset from two or more end-user entities who are in a same group or unit, have the same title, are in the same or nearby geographic locations, and so forth. In one example, the relationships that are identified may be according to rules/policies that are pre-designated for application at phase 5-stage 2. In addition, the inference engine 220 may record ninth metadata for the second enhanced dataset, the ninth metadata including an indication of the relationship(s) among usage of the second enhanced dataset by the plurality of end-user entities that is/are detected.

Lastly, at phase 5-stage 3, the intelligent analyzer 230 may apply polices to derive insights based upon the eighth and ninth metadata generated at stages 1 and 2 of phase 5. For instance, a policy may define that a report should be generated with information regarding how the second enhanced dataset compares to other available datasets in terms of the number of requests, the number of uses, etc. In one example, statistics may be generated to compare the second enhanced dataset to other datasets associated with a particular category or subject-matter area. In one example, statistics may alternatively or additionally include a ranking of the second enhanced dataset compared to other datasets (e.g., overall and/or with respect to a particular category), where the rankings may be based upon user feedback on the performance of the second enhanced dataset with respect to a machine learning task or other uses, user feedback regarding the usefulness of the natural language explanation in understanding and/or expediting evaluation of the second enhanced dataset, and so forth. In one example, the insights generated via policies at phase 5-stage 3 may be recorded by the intelligent analyzer 230 as tenth metadata.

It should also be noted that in one example, the policies for application at phase 5 (and in one example, also those for application at phase 4) may be designated by operator personnel who may be different from those who define/designate policies for phases 2 and/or 3. For instance, phase 5 policies may be set by operator personnel who may have roles that involve interactions with end-users who may be consumers of datasets, such as the second enhanced dataset. Thus, for example, the end-users may provide feedback as to which information is most useful in terms of utilization of datasets, relationships among end-user entities who are requesting and/or utilizing datasets, and so forth. Accordingly, these end-user-facing operator personnel may be responsive to the feedback and preferences of end-user entities by setting and/or adjusting phase 5 policies.

In one example, metadata from phase 5 may be re-incorporated into information that may be processed by the metadata generator 210, the inference engine 220, and the intelligent analyzer 230 at phase 4, stages 1-3, respectively. For instance, the natural language explanation for the second enhanced dataset may be updated to include information derived from the 8^{th}-10^{th} metadata from phase 5. In addition, it should be noted that in one example, the operations of phases 1-5 (or at least phases 2-5), and stages 1-3 of each phase, may continue. For instance, data may continue to be collected per phase 2, added to the first dataset, combined with at least the second dataset to update the first enhanced dataset, combined with at least the third dataset to update the second enhanced dataset, and so forth. In addition, older data of any of the first dataset, the second dataset, the third dataset, the first enhanced dataset, or the second enhanced dataset may continue to be archived, truncated, summarized, averaged, and so forth according to policies that are implemented at various phases and stages. In addition, metadata may continue to be automatically generated and recorded pertaining to the policies that are implemented (e.g., when the respective condition(s) are met), the actions taken, and so forth.

It should also be noted that the processing system 200 may process multiple datasets in a similar manner as described above, or multiple instances of the processing system 200 may operate in parallel, each processing one or more datasets in the same or a similar manner. In summary, metadata for each dataset may be continuously generated and appended in each of the 5 phases. Within a single phase, metadata may be recorded or derived in at least three stages. The first stage records and generates “plain” or “initial” metadata. The second stage analyzes that metadata and identifies/establishes relationships with metadata of other datasets, recording such relationships as “additional” metadata. The final stage may use inference policies to further derive “intelligent” or “successive” metadata by generating statistical insights. Thus initial, additional, and successive metadata may be recorded in each phase of operation. In addition, in one example, metadata may be stored and grouped by phase (e.g., 1^{st}-3^{rd} metadata together, 4^{th}-6^{th} metadata together, etc.). In one example, the metadata may be stored and appended to the respective datasets. In another example, the metadata may be stored in a separate metadata repository, but may be linked to the corresponding datasets.

It should also be noted that in various examples, in addition to the architectural components illustrated in FIG. 2, the processing system 200 may include other modules (not shown) such as: a listener/trigger handler module, an event history linker module, a request handler module, a fulfillment planner/scheduler module, a smart metadata search module, and an explanation generation module. For instance, several of the modules may be involved in processing queries/requests from end-users. For example, a request handler may initially receive and validate end-user requests (it is again noted that an end-user can be a human or an automated system). A fulfillment planner/scheduler module may parse and interpret end-user requests/specifications. For instance, a query or request may be divided into separately executable query tasks to be fulfilled sequentially and/or in parallel. A smart metadata search module may provide search criteria ranking/weighting, search formation, search ordering, search history examination, and retrieved metadata parsing. For instance, the smart metadata search module may apply weightings to search criteria, e.g. each criteria weighted 1-10, ordering of search sub-tasks, e.g., where each focuses on one search criterion/requirement, organizing datasets by “closeness” to search requirements, generating explanations of how the “close” datasets resulting from a search differ from search criteria and/or from each other, and so forth. In one example, the smart metadata search module may also invoke a metadata handling module to fulfill the task of comparing and contrasting datasets to the search criteria and to each other. In one example, a search may be designated as a “strict” search or a “loose” search, where the smart metadata search module may vary the search stage ordering and/or the ranking or weighting of criteria (within default limits or limits set/chosen by the end-user). The smart metadata search module may also account for a time history of processing steps (e.g. multiple different filtering operations may have been applied to a dataset, and at different times), categorizations of processing steps, consideration of reversible versus irreversible steps, e.g., filtering with loss of data, etc.

As another example, an explanation generation module may be invoked at phase 4 to generate natural language explanations from available 1^{st}-6^{th} and/or 8^{th}-10^{th} metadata. The explanation generation module may comprise a natural language generator (NLG) that transforms structured data into natural language. For instance, an NLG process may be implemented via a machine learning model, such as a Markov decision process, a recurrent neural network (RNN), a long short-term memory (LSTM) neural network, and so forth. In another example, the natural language explanation generation may be invoked in response to a query/request for a dataset. For instance, the processing system 200 may wait until a dataset is requested, in response to which the explanation generation module may be invoked. Thus, the processing overhead of the NLG may be conserved until a dataset may actually be queried and/or requested.

In one example, an event history linker module may provide a trusted data operations history. In one example, the history may allow an end-user examining datasets to undo various data processing operations. For instance, an end-user may determine that the first enhanced dataset is desired, and that data from the second domain (e.g., the data from the third dataset that is included in the second enhanced dataset) is not desired. In other words, the end-user is specifically interested in data from the original domain (e.g., of telecommunication network data) and not from an additional domain (e.g., OTT streaming service data). Thus, the event history linker may provide a view of the operations performed on the data, the order of the operations, etc. To the extent possible, the end-user may then work backwards to undo operations, or may specifically request the first enhanced dataset (without further enhancement), e.g., to the extent that the first enhanced dataset may still be stored in a useable form and has not been deleted, archived, aggregated/summarized, etc. Accordingly, it should be noted that FIG. 2 illustrates just one example architecture of a processing system 200 for associating different datasets and enhancing datasets with metadata according to multiple sets of policies.

FIG. 3 illustrates a flowchart of at least a portion of an example method 300 for associating different datasets and enhancing datasets with metadata according to multiple sets of policies, according to the present disclosure. In one example, the method 300 is performed by a component of the system 100 of FIG. 1, such as by server(s) 135, and/or any one or more components thereof (e.g., a processor, or processors, performing operations stored in and loaded from a memory or distributed memory system), or by server(s) 135, in conjunction with one or more other devices, such as server(s) 155, and so forth. In one example, the method 300 may be performed by a processing system, such as processing system 200 of FIG. 2. In one example, the steps, functions, or operations of method 300 may be performed by a computing device or processing system, such as computing system 500 and/or a hardware processor element 502 as described in connection with FIG. 5 below. For instance, the computing system 500 may represent at least a portion of a platform, a server, a system, and so forth, in accordance with the present disclosure. In one example, the steps, functions, or operations of method 300 may be performed by a processing system comprising a plurality of such computing devices as represented by the computing system 500. For illustrative purposes, the method 300 is described in greater detail below in connection with an example performed by a processing system (e.g., deployed in a telecommunication network). The method 300 begins in step 305 and may proceed to optional step 310 or to step 315.

At optional step 310, the processing system may obtain, in accordance with one or more policy templates, one or more of a first set of policies, a second set of policies, a third set of policies, a fourth set of policies, a fifth set of policies, or a sixth set of policies. For instance, the 1^{st}-6^{th} sets of policies may be for a data processing phase and an after-processing phase of a multi-phase data processing pipeline. In one example, optional step 310 may be in accordance with a pre-processing phase that precedes the data processing phase (e.g., as described above in connection with the example of FIG. 2). In one example, optional step 310 may further include obtaining 7^{th}-10^{th} sets of policies, e.g., for a data explanation phase (DEP), and a data exploration and use phase (DEUP) of the multi-phase data processing pipeline.

At step 315, the processing system generates a first dataset according to a first set of policies. For instance, the first set of policies may be obtained via one or more policy templates from operations personnel at optional step 310. For instance, the first set of policies may include at least one data collection policy, such as: a time for collecting data of the first dataset, a frequency for collecting the data of the first dataset, one or more sources for collecting the data of the first dataset, a geographic region or a network zone for collecting the data of the first dataset, at least one type of data to collect for the data of the first dataset, and so forth. In addition, the first set of policies may include at least one data processing policy comprising at least one condition (e.g., at least one “first” condition), and at least one action (e.g., at least one “first” action), which may comprise, for example: combining operations for the data of the first dataset, aggregating operations for the data of the first dataset (e.g., averaging, creating 30 minute files averaging raw data, sampling, recording 25% or 75% percentiles, and so forth), and/or enhancing operations for the data of the first dataset. The data processing policies of the first set of policies may be applied with respect to at least a portion of a first domain (e.g., data from a region or zone of a telecommunication network).

At step 320, the processing system records first metadata for the first dataset, the first metadata including information associated with at least one policy of the first set of policies that is applied during the generating of the first dataset. For instance, steps 315 and 320 may be the same as or similar to operations described above in connection with phase 2-stage 1 of the example of FIG. 2.

At step 325, the processing system generates a first enhanced dataset that is derived from at least a portion of the first dataset and at least a portion of a second dataset, according to a second set of policies. For instance, the second set of policies may be obtained at optional step 310 as described above. In one example, each of the second set of policies comprises at least one “second” condition and at least one “second” action to associate the first dataset with at least the second dataset. It should also be noted that although the terms, “first,” “second,” “third,” etc., are used herein, the use of these terms are intended as labels only. Thus, the use of a term such as “third” in one example does not necessarily imply that the example must in every case include a “first” and/or a “second” of a similar item. In other words, the use of the terms “first,” “second,” “third,” and “fourth,” does not necessarily imply a particular number of those items corresponding to those numerical values. In addition, the use of the term “third” for example, does not imply a specific sequence or temporal relationship with respect to a “first” and/or a “second” of a particular type of item, unless otherwise indicated.

In one example, the at least one second condition is to identify at least one relationship between the first metadata of the first dataset and metadata of the second dataset, and the at least one second action is to be implemented responsive to an identification of the relationship according to the at least one second condition. For instance, the at least one second action may comprise combining at least the portion of the first dataset with at least the portion of the second dataset, aggregating at least one of: at least the portion of the first dataset, at least the portion of the second dataset, or at least a portion of the first enhanced dataset, and/or enhancing at least the portion of the first enhanced dataset. In one example, the at least one second condition includes a distance metric for identifying the at least one relationship. For example, the distance metric may be associated with at least one of: a geographic distance, a network topology-based distance, or a similarity distance for one or more features of the first metadata of the first dataset and the metadata of the second dataset.

At step 330, the processing system records second metadata for the first enhanced dataset, the second metadata including information associated with at least one policy of the second set of policies that is applied to associate the first dataset with the at least the second dataset. For instance, steps 325 and 330 may be the same as or similar to operations described above in connection with phase 2-stage 2 of the example of FIG. 2. In one example, the first metadata may be incorporated into the second metadata. In another example, the first metadata may be linked to the second metadata, e.g., to provide an event history relating to processing of the first dataset.

At optional step 335, the processing system may apply a third set of policies to the first enhanced dataset, wherein each of the third set of policies comprises at least one “third” condition and at least one “third” action to generate statistical data regarding the first enhanced dataset.

At optional step 340, the processing system may record third metadata for the first enhanced dataset, the third metadata including the statistical data regarding the first enhanced dataset. In addition, the third metadata may further include information associated with at least one policy of the third set of policies that is applied to generate the statistical data regarding the first enhanced dataset. For instance, optional steps 335 and 340 may be the same as or similar to operations described above in connection with phase 2-stage 3 of the example of FIG. 2.

At optional step 345, the processing system may apply a fourth set of policies to the first enhanced dataset, where each of the fourth set of policies comprises at least one “fourth” condition and at least one “fourth” action to apply to the first enhanced dataset.

At optional step 350, the processing system may record fourth metadata for the first enhanced dataset, the fourth metadata including information associated with at least one policy of the fourth set of policies that is applied with respect to the first enhanced dataset. It should be noted that conditions of the policies of the fourth set of policies may be of the same or a similar nature as those of the first, second, and third sets of policies. Similarly, the corresponding actions may include combining operations, aggregating operations, and/or enhancing operations with respect to the data of the first enhanced dataset (it should be noted that the “combining” may be for different columns, rows, tables, fields, partitions, graphs, etc. within the first enhanced dataset itself, and does not involve any other datasets). In one example, optional steps 345 and 350 may be the same as or similar to operations described above in connection with phase 3-stage 1 of the example of FIG. 2.

At step 355, the processing system generates a second enhanced dataset that is derived from at least a portion of the first enhanced dataset and at least a portion of a third dataset according to a fifth set of policies. In one example, each of the fifth set of policies comprises at least one “fifth” condition and at least one “fifth” action to associate the first enhanced dataset with at least the third dataset. It should be noted that with respect to step 355, the first dataset and the at least the second dataset are from a first domain, and the at least the third dataset is from at least a second domain that is different from the first domain. For instance, the first dataset and second dataset (and hence the first enhanced dataset) may be telecommunication network records from two regions of a telecommunication network (e.g., television viewing data), and at least the third dataset may be viewing data from an OTT streaming service, an online social network, etc.

In one example, the at least one fifth condition is to identify at least one relationship between metadata of the third dataset and at least one of the 1^{st}-4^{th} metadata, and the at least one fifth action is to be implemented responsive to an identification of the relationship according to the at least one fifth condition. For instance, the at least one fifth action may comprise: (1) combining at least the portion of the first enhanced dataset with at least the portion of the third dataset, (2) aggregating at least one of: at least the portion of the first enhanced dataset, at least the portion of the third dataset, or the second enhanced dataset, and/or (3) enhancing at least one of: at least the portion of the first enhanced dataset, at least the portion of the third dataset, or the second enhanced dataset. In one example, the at least one fifth condition may also include an inter-domain “distance metric,” e.g., similar to the second set of policies for intra-domain data associations of step 325.

At step 360, the processing system records fifth metadata for the second enhanced dataset, the fifth metadata including information associated with at least one policy of the fifth set of policies to associate the first enhanced dataset with at least the third dataset. In one example, steps 355 and 360 may be the same as or similar to operations described above in connection with phase 3-stage 2 of the example of FIG. 2.

At optional step 365, the processing system may apply a sixth set of policies to the second enhanced dataset, where each of the sixth set of policies comprises at least one sixth condition and at least one sixth action to generate statistical data regarding the second enhanced dataset.

At optional step 370, the processing system may record sixth metadata for the second enhanced dataset, the sixth metadata including the statistical data regarding the second enhanced dataset, and further including information associated with at least one policy of the sixth set of policies that is applied to generate the statistical data regarding the second enhanced dataset. In one example, optional steps 365 and 370 may be the same as or similar to operations described above in connection with phase 3-stage 3 of the example of FIG. 2. In addition, the at least the sixth condition may be similar to the at least the third condition of the third set of policies that may be applied at optional step 335 (however with respect to the second enhanced dataset), and may be evaluated against the 1^{st}-5^{th} metadata that may be generated at prior stages and phases. For instance, the statistical data may comprise analysis of metadata (e.g., comparisons, contrasts, and/or differences between metadata), a trending report of data of various tables, rows, columns, clusters, etc., a report of high, low, and median values for various fields of data in the first enhanced dataset, and so forth.

At optional step 375, the processing system may generate a natural-language explanation of the second enhanced dataset based upon at least a portion of metadata selected from among the 1^{st}-6^{th} metadata. For instance, the processing system may apply a natural language generator (NLG) that transforms structured data into natural language. For instance, an NLG process may be implemented via a machine learning model, such as a Markov decision process, a recurrent neural network (RNN), a long short-term memory (LSTM) neural network, and so forth, with the 1^{st}-6^{th} metadata as inputs. In one example, optional step 375 may be in accordance with a seventh set of policies which may include at least one policy to define preferences with respect to which metadata of the 1^{st}-6^{th} metadata should be utilized as inputs to the NLG.

At optional step 380, the processing system may record the natural-language explanation of the second enhanced dataset as seventh metadata. For instance, in one example, optional steps 375 and 380 may be the same as or similar to operations described above in connection with phase 4 of the example of FIG. 2.

At step 385, the processing system may add the second enhanced dataset to a dataset catalog comprising a plurality of datasets. For instance, the catalog of datasets may be searchable and queryable by end-users (or automated end-user entities), and may be provided to such end-user entities, such as described in greater detail below in connection with the example method 400 of FIG. 4. It should be noted that in one example, the first dataset, the second dataset, the first enhanced dataset, and the second enhanced dataset may all be part of the plurality of datasets, and may similarly be stored in the catalog in accordance with respective data retention policies for each of the datasets (which may be contained within the first set of policies, the second set of policies, the fourth set of policies, and/or the fifth set of policies, for instance). Similarly, in one example, all of the 1^{st}-7^{th} metadata may be stored and appended to the respective datasets. In another example, the metadata may be stored in a separate metadata repository, but may be linked to the corresponding datasets (and annotated with links among the 1^{st}-7^{th} metadata such that an entire event history of policies invoked, and the actions taken with respect to processing the first dataset may be retained). Following step 385, the method 300 proceeds to step 395 where the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300, such as steps 315-360, steps 315-385, and so forth. For instance, data may continue to be collected, added to the first dataset, combined with at least the second dataset to update the first enhanced dataset, combined with at least the third dataset to update the second enhanced dataset, and so forth. In addition, older data of any of the first dataset, the second dataset, the third dataset, the first enhanced dataset, or the second enhanced dataset may continue to be archived, truncated, summarized, averaged, and so forth according to polices that are implemented at various phases and stages. In addition, metadata may continue to be automatically generated and recorded pertaining to the policies that are implemented (e.g., when the respective condition(s) are met), the actions taken, and so forth. It should also be noted that in one example, the method 300 may be combined with the method 400, which describes additional operations in connection with a query and/or request involving the second enhanced dataset, the use of the second enhanced dataset, etc. For instance, in one example, the method 400 may comprise a continuation of the method 300. Thus, these and other modifications are all contemplated within the scope of the present disclosure.

FIG. 4 illustrates a flowchart of at least a portion of an example method 400 for associating different datasets and enhancing datasets with metadata according to multiple sets of policies, according to the present disclosure. In one example, the method 400 is performed by a component of the system 100 of FIG. 1, such as by server(s) 135, and/or any one or more components thereof (e.g., a processor, or processors, performing operations stored in and loaded from a memory or distributed memory system), or by server(s) 135, in conjunction with one or more other devices, such as server(s) 155, and so forth. In one example, the method 400 may be performed by a processing system, such as processing system 200 of FIG. 2. In one example, the steps, functions, or operations of method 400 may be performed by a computing device or processing system, such as computing system 500 and/or a hardware processor element 502 as described in connection with FIG. 5 below. For instance, the computing system 500 may represent at least a portion of a platform, a server, a system, and so forth, in accordance with the present disclosure. In one example, the steps, functions, or operations of method 400 may be performed by a processing system comprising a plurality of such computing devices as represented by the computing system 500. For illustrative purposes, the method 400 is described in greater detail below in connection with an example performed by a processing system (e.g., deployed in a telecommunication network). The method 400 begins in step 405 and proceeds to step 410.

At step 410, the processing system may obtain a request for a dataset from a dataset catalog, where the request is obtained from an end-user entity, and where the request is in a format according to a request template. For instance, the dataset catalog may be the same dataset catalog as mentioned above in connection with step 385 of the method 300, and may include at least the second enhanced dataset.

At step 420, the processing system may search the dataset catalog for one or more datasets from the dataset catalog responsive to the request. For instance, the searching may comprise matching one or more parameters that are specified in the request according to the request template to one or more aspects of respective metadata of the one or more datasets (e.g., where the one or more datasets responsive to the request includes at least the second enhanced dataset). For example, at least one of the 1^{st}-6^{th} metadata (of the second enhanced dataset and/or associated with the second enhanced dataset) may comprise at least one aspect that is matched to at least one of the one or more parameters that are specified in the request.

At step 430, the processing system may provide a response to the end-user entity indicating the one or more datasets (including at least the second enhanced dataset) responsive to the request. It should be noted that in one example, an end-user entity may submit the request, and the request may match to first dataset because of the first metadata (e.g., where the first dataset is also stored in the catalog). However, the result may return the second enhanced dataset because of the process of the present disclosure to associate and aggregate the first dataset with additional data from same domain and one or more other domains to generate the second enhanced dataset. In one example, step 430 may include providing natural-language explanations associated with each of the one or more datasets, which may include at least a natural-language explanation of the second enhanced dataset. For instance, the natural-language explanation of the second enhanced dataset may be generated in accordance with optional step 375 of the method 300, as discussed above.

At step 440, the processing system may obtain a selection of the second enhanced dataset by an end-user entity (e.g., a same end-user entity as described in connection with steps 410-430 or a different end-user entity). For instance, in one example, the end-user entity may have previously searched the catalog, prior to selecting the second enhanced dataset for use. In another example, the end-user entity may select the second enhanced dataset directly. For instance, another end-user may have directed the end-user as to which dataset(s) to use (in which case, the end-user may skip steps 410-430).

At step 450, the processing system may record eighth metadata (e.g., for the second enhanced dataset and/or associated with the second enhanced dataset), the eighth metadata including an indication of the selection of the second enhanced dataset (such as a timestamp, an identification of an end-user or system selecting the second enhanced dataset, the type of end-user or group (e.g., marketing, operations, customer care, etc.), and so forth).

At step 460, the processing system may obtain feedback regarding a use of the second enhanced dataset by the end-user entity. In addition, the feedback regarding the use of the second enhanced dataset by the end-user entity may be included in the eighth metadata. In one example, the types of information and the conditions under which the eight metadata should be recorded may be defined in an eighth set of policies. It should also be noted that in one example, the eighth metadata, or a natural-language explanation including the eighth metadata may be provided in response to subsequent requests that may return the second enhanced dataset. (For instance, in one example, the eighth metadata may be utilized in the operations of optional steps 375 and 380 of the method 300). In one example, steps 410-460 may be the same as or similar to operations described above in connection with phase 5-stage 1 of the example of FIG. 2.

At step 470, the processing system may identify relationships among usage of the second enhanced dataset by a plurality of end-user entities, e.g., according to a ninth set of policies.

At step 480, the processing system may record ninth metadata for the second enhanced dataset, the ninth metadata including an indication of the relationships among usage of the second enhanced dataset by the plurality of end-user entities. For instance, the ninth set of policies may define the types of relationships that are to be looked for, the circumstances under which an identification of the types of relationships should be recorded, the information about the identification that is to be recorded, and so forth. In one example, steps 470 and 480 may be the same as or similar to operations described above in connection with phase 5-stage 2 of the example of FIG. 2. Following step 480, the method 400 may proceeds to step 495 where the method 400 ends.

It should be noted that the method 400 may be expanded to include additional steps, or may be modified to replace steps with different steps, to combine steps, to omit steps, to perform steps in a different order, and so forth. For instance, in one example, the processing system may repeat one or more steps of the method 400, such as steps 410-480, steps 440-480, and so forth. For instance, additional queries and/or requests may be obtained, end-users entities may use the second enhanced dataset, and metadata may continue to be automatically generated and recorded pertaining to the policies that are implemented (e.g., when the respective condition(s) are met), the actions taken, and so forth with respect to the querying, requesting, and/or using of the second enhanced dataset. In one example, the method 400 may be expanded to include applying a tenth set of policies, and generating and recording tenth metadata, e.g., as described above in connection with operations of the intelligent analyzer 230 at phase 5-stage 3 in the example of FIG. 2. In still another example, the method 400 may be expanded to include providing an interface to enable an end-user to explore an event history (based upon the metadata), to enable the end-user to select one or more actions to undo, and to execute operations to undo the prior actions. For instance, in one example, the end-user may desire the first enhanced dataset, without the data of the at least the third dataset from an external domain. Accordingly, the processing system may retrieve the first enhanced dataset from the dataset catalog or repository (e.g., when the first enhanced dataset has also been retained in storage). Alternatively, or in addition, the processing system may actively undo certain actions (e.g., those that may be reversible) in accordance with the selection(s) of the end-user. It should also be noted that in one example, the method 400 may be combined with the method 300, which describes additional operations in connection with generation of the second enhanced dataset, and the associated 1^{st}-6^{th} metadata. For instance, in one example, the method 400 may comprise a continuation of the method 300. Thus, these and other modifications are all contemplated within the scope of the present disclosure.

In addition, although not expressly specified above, one or more steps of the method 300 or the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIGS. 3 and 4 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 5 depicts a high-level block diagram of a computing system 500 (e.g., a computing device or processing system) specifically programmed to perform the functions described herein. For example, any one or more components, devices, and/or systems illustrated in FIG. 1 or FIG. 2, or described in connection with FIGS. 1-4, may be implemented as the computing system 500. As depicted in FIG. 5, the computing system 500 comprises a hardware processor element 502 (e.g., comprising one or more hardware processors, which may include one or more microprocessor(s), one or more central processing units (CPUs), and/or the like, where the hardware processor element 502 may also represent one example of a “processing system” as referred to herein), a memory 504, (e.g., random access memory (RAM), read only memory (ROM), a disk drive, an optical drive, a magnetic drive, and/or a Universal Serial Bus (USB) drive), a module 505 for associating different datasets and enhancing datasets with metadata according to multiple sets of policies, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 502 is shown, the computing system 500 may employ a plurality of hardware processor elements. Furthermore, although only one computing device is shown in FIG. 5, if the method(s) as discussed above is implemented in a distributed or parallel manner for a particular illustrative example, e.g., the steps of the above method(s) or the entire method(s) are implemented across multiple or parallel computing devices, then the computing system 500 of FIG. 5 may represent each of those multiple or parallel computing devices. Furthermore, one or more hardware processor elements (e.g., hardware processor element 502) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 502 can also be configured or programmed to cause other devices to perform one or more operations as discussed above. In other words, the hardware processor element 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 505 for associating different datasets and enhancing datasets with metadata according to multiple sets of policies (e.g., a software program comprising computer-executable instructions) can be loaded into memory 504 and executed by hardware processor element 502 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 502) executing the computer-readable instructions relating to the above described method(s) can be perceived as a programmed processor or a specialized processor. As such, the present module 505 for associating different datasets and enhancing datasets with metadata according to multiple sets of policies (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server. While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
generating, by a processing system including at least one processor, a first dataset according to a first set of policies;
recording, by the processing system, first metadata for the first dataset, the first metadata including information associated with at least one policy of the first set of policies that is applied during the generating of the first dataset;
generating, by the processing system, a first enhanced dataset that is derived from at least a portion of the first dataset and at least a portion of a second dataset, according to a second set of policies, wherein each of the second set of policies comprises at least one second condition and at least one second action to associate the first dataset with at least the second dataset;
recording, by the processing system, second metadata for the first enhanced dataset, the second metadata including information associated with at least one policy of the second set of policies that is applied to associate the first dataset with the at least the second dataset;
generating, by the processing system, a second enhanced dataset that is derived from at least a portion of the first enhanced dataset and at least a portion of a third dataset according to a fifth set of policies, wherein each of the fifth set of policies comprises at least one fifth condition and at least one fifth action to associate the first enhanced dataset with at least the third dataset, wherein the first dataset and the at least the second dataset are from a first domain, and wherein the at least the third dataset is from at least a second domain that is different from the first domain;
recording, by the processing system, fifth metadata for the second enhanced dataset, the fifth metadata including information associated with at least one policy of the fifth set of policies to associate the first enhanced dataset with at least the third dataset; and
adding, by the processing system, the second enhanced dataset to a dataset catalog comprising a plurality of datasets.

2. The method of claim 1, wherein the at least one policy of the first set of policies is associated with at least one of:
a time for collecting data of the first dataset;
a frequency for collecting the data of the first dataset;
one or more sources for collecting the data of the first dataset;
a geographic region or a network zone for collecting the data of the first dataset; or
at least one type of data to collect for the data of the first dataset.

3. The method of claim 1, wherein the at least one policy of the first set of policies comprises:
at least one first condition; and
at least one first action, the at least one first action comprising at least one of:
a combining operation for the data of the first dataset;
an aggregating operation for the data of the first dataset; or
an enhancing operation for the data of the first dataset.

4. The method of claim 1, wherein the at least one second condition is to identify at least one relationship between the first metadata of the first dataset and metadata of the second dataset, and wherein the at least one second action is to be implemented responsive to an identification of the relationship according to the at least one second condition, wherein the at least one second action comprises at least one of:
combining at least the portion of the first dataset with at least the portion of the second dataset;
aggregating at least one of: at least the portion of the first dataset, at least the portion of the second dataset, or at least a portion of the first enhanced dataset; or
enhancing at least the portion of the first enhanced dataset.

5. The method of claim 1, further comprising:
applying a third set of policies to the first enhanced dataset, wherein each of the third set of policies comprises at least one third condition and at least one third action to generate statistical data regarding the first enhanced dataset; and
recording third metadata for the first enhanced dataset, the third metadata including the statistical data regarding the first enhanced dataset, and wherein the third metadata further includes information associated with at least one policy of the third set of policies that is applied to generate the statistical data regarding the first enhanced dataset.

6. The method of claim 5, further comprising:
applying a fourth set of policies to the first enhanced dataset, wherein each of the fourth set of policies comprises at least one fourth condition and at least one fourth action to apply to the first enhanced dataset, wherein the fourth set of policies is applied prior to generating the second enhanced dataset; and
recording fourth metadata for the first enhanced dataset, the fourth metadata including information associated with at least one policy of the fourth set of policies that is applied with respect to the first enhanced dataset.

7. The method of claim 6, wherein the at least one fourth action comprises at least one of:
a combining operation for the data of the first enhanced dataset;
an aggregating operations for the data of the first enhanced dataset; or
an enhancing operations for the data of the first enhanced dataset.

8. The method of claim 6, wherein the at least one fifth condition is to identify at least one relationship between metadata of the third dataset and at least one of the first metadata, the second metadata, the third metadata, or the fourth metadata, wherein the at least one fifth action is to be implemented responsive to an identification of the relationship according to the at least one fifth condition, and wherein the at least one fifth action comprises at least one of:
combining at least the portion of the first enhanced dataset with at least the portion of the third dataset;
aggregating at least one of: at least the portion of the first enhanced dataset, at least the portion of the third dataset, or the second enhanced dataset; or
enhancing at least one of: at least the portion of the first enhanced dataset, at least the portion of the third dataset, or the second enhanced dataset.

9. The method of claim 6, further comprising:
applying a sixth set of policies to the second enhanced dataset, wherein each of the sixth set of policies comprises at least one sixth condition and at least one sixth action to generate statistical data regarding the second enhanced dataset; and
recording sixth metadata for the second enhanced dataset, the sixth metadata including the statistical data regarding the second enhanced dataset, and wherein the sixth metadata further includes information associated with at least one policy of the sixth set of policies that is applied to generate the statistical data regarding the second enhanced dataset.

10. The method of claim 9, wherein the generating of the first dataset and the applying of the fourth set of policies are via a first module implemented via the processing system, wherein the generating of the first enhanced dataset and the generating of the second enhanced dataset are via a second module implemented via the processing system, and wherein the applying of the third set of policies and the applying of the sixth set of policies are via a third module implemented via the processing system.

11. The method of claim 9, wherein the generating of the first dataset, the generating of the first enhanced dataset, and the applying of the third set of policies comprise a second phase of a multi-phase data processing pipeline for processing datasets by the processing system; and
wherein the applying of the fourth set of policies, the generating of the second enhanced dataset, and the applying of the sixth set of policies comprise a third phase of the multi-phase data processing pipeline that is after the second phase.

12. The method of claim 11, further comprising:
obtaining, in accordance with one or more policy templates, one or more of the first set of policies, the second set of policies, the third set of policies, the fourth set of policies, the fifth set of policies, or the sixth set of policies, wherein the obtaining comprises a first stage of the multi-phase data processing pipeline that is prior to the second stage.

13. The method of claim 1, further comprising:
generating a natural-language explanation of the second enhanced dataset based upon at least a portion of metadata selected from among: the first metadata, the second metadata, the third metadata, the fourth metadata, the fifth metadata, and the sixth metadata; and
recording the natural-language explanation of the second enhanced dataset as seventh metadata.

14. The method of claim 13, further comprising:
obtaining a request for a dataset from the dataset catalog, wherein the request is obtained from an end-user entity, wherein the request is in a format according to a request template;
searching the dataset catalog for one or more datasets from the dataset catalog responsive to the request, wherein the searching comprises matching one or more parameters that are specified in the request according to the request template to one or more aspects of respective metadata of the one or more datasets, wherein the one or more datasets include at least the second enhanced dataset; and
providing a response to the end-user entity indicating the one or more datasets including at least the second enhanced dataset responsive to the request.

15. The method of claim 14, wherein the providing the response includes providing a natural-language explanation associated with each of the one or more datasets, wherein the natural-language explanation includes at least the natural-language explanation of the second enhanced dataset.

16. The method of claim 1, further comprising:
obtaining a selection of the second enhanced dataset by an end-user entity; and
recording eighth metadata, the eighth metadata including an indication of the selection of the second enhanced dataset.

17. The method of claim 16, further comprising:
obtaining feedback regarding a use of the second enhanced dataset by the end-user entity, wherein the feedback regarding the use of the second enhanced dataset by the end-user entity is included in the eighth metadata.

18. The method of claim 17, further comprising:
identifying relationships among usage of the second enhanced dataset by a plurality of end-user entities; and
recording ninth metadata for the second enhanced dataset, the ninth metadata including an indication of the relationships among usage of the second enhanced dataset by the plurality of end-user entities.

19. A non-transitory computer-readable medium storing instructions which, when executed by a processing system including at least one processor, cause the processing system to perform operations, the operations comprising:
generating a first dataset according to a first set of policies;
recording first metadata for the first dataset, the first metadata including information associated with at least one policy of the first set of policies that is applied during the generating of the first dataset;
generating a first enhanced dataset that is derived from at least a portion of the first dataset and at least a portion of a second dataset, according to a second set of policies, wherein each of the second set of policies comprises at least one second condition and at least one second action to associate the first dataset with at least the second dataset;
recording second metadata for the first enhanced dataset, the second metadata including information associated with at least one policy of the second set of policies that is applied to associate the first dataset with the at least the second dataset;
generating a second enhanced dataset that is derived from at least a portion of the first enhanced dataset and at least a portion of a third dataset according to a fifth set of policies, wherein each of the fifth set of policies comprises at least one fifth condition and at least one fifth action to associate the first enhanced dataset with at least the third dataset, wherein the first dataset and the at least the second dataset are from a first domain, and wherein the at least the third dataset is from at least a second domain that is different from the first domain;
recording fifth metadata for the second enhanced dataset, the fifth metadata including information associated with at least one policy of the fifth set of policies to associate the first enhanced dataset with at least the third dataset; and
adding the second enhanced dataset to a dataset catalog comprising a plurality of datasets.

20. A device comprising:
a processor system including at least one processor; and
a computer-readable medium storing instructions which, when executed by the processing system, cause the processing system to perform operations, the operations comprising:
generating a first dataset according to a first set of policies;
recording first metadata for the first dataset, the first metadata including information associated with at least one policy of the first set of policies that is applied during the generating of the first dataset;
generating a first enhanced dataset that is derived from at least a portion of the first dataset and at least a portion of a second dataset, according to a second set of policies, wherein each of the second set of policies comprises at least one second condition and at least one second action to associate the first dataset with at least the second dataset;
recording second metadata for the first enhanced dataset, the second metadata including information associated with at least one policy of the second set of policies that is applied to associate the first dataset with the at least the second dataset;
generating a second enhanced dataset that is derived from at least a portion of the first enhanced dataset and at least a portion of a third dataset according to a fifth set of policies, wherein each of the fifth set of policies comprises at least one fifth condition and at least one fifth action to associate the first enhanced dataset with at least the third dataset, wherein the first dataset and the at least the second dataset are from a first domain, and wherein the at least the third dataset is from at least a second domain that is different from the first domain;
recording fifth metadata for the second enhanced dataset, the fifth metadata including information associated with at least one policy of the fifth set of policies to associate the first enhanced dataset with at least the third dataset; and
adding the second enhanced dataset to a dataset catalog comprising a plurality of datasets.
